(19) United States
(12) Patent Application Publication
(10) Pub. No.: US 2006/0212848 A1
(43) Pub. Date: Sep. 21, 2006

(54) Apparatus for managing configuration of application software

(75) Inventors: Kiyotaka Kasubuchi, Kyoto (JP); Hiroshi Yamamoto, Kyoto (JP)

Correspondence Address: MCDERMOTT WILL & EMERY LLP, 600 13TH STREET, N.W., WASHINGTON, DC, 20005-3096, US

(73) Assignee: DAINIPPON SCREEN MFG.CO., LTD.

(21) Appl. No.: 11/360,533

(22) Filed: Feb. 24, 2006

(30) Foreign Application Priority Data
Mar. 18, 2005 (JP) JP2005-078300

(51) Int. Cl. G06F 9/44

(52) U.S. Cl. 717/121

(57) ABSTRACT

When a program module specification change element changes a program module specification described in an application software specification, a program module change element changes a program module associated with the changed program module specification. This achieves a change in a configuration of application software.

### BACKGROUND OF THE INVENTION

1. Field of the Invention

The present invention relates to an apparatus for managing a configuration of application software having a plurality of program modules and module-configuration described in the form of a digital specification file.

2. Description of the Background Art

Application software for execution in a computer includes a plurality of program modules such as a program module for executing a principal function, a program module related to input and output, a program module related to display, and the like.

There are occasions when such a program module is shared between a plurality of pieces of application software. Sometimes, a program module used in a preceding version is used again after a version upgrade of application software.

In such cases, there has arisen a problem in that the management of program modules constituting application software becomes complicated. Specifically, it is assumed that, when a version upgrade of two pieces of application software is performed, an input/output-related program module remains shared between the two pieces of application software whereas display-related program modules are updated in the respective pieces of application software. Because the input/output-related program module is shared, all of the program modules in each of the two pieces of application software cannot be updated in a collective manner but are required to be updated one by one. For only the display-related program modules as an example, it is necessary to perform the process of searching for an appropriate program module by using the exact matching or prefix matching of program module names, and then replacing the program module found by the search with a new program module.

For a version upgrade of a single piece of application software which does not involve the change of an input/output-related program module but involves the change of a display-related program module, it is similarly necessary to perform the process of updating only the display-related program module.

Thus, a variety of techniques have conventionally been proposed for program module configurations of application software and for management of revisions thereof. An example of such techniques is disclosed, for example, in Japanese Patent Application Laid-Open No. 2001-256258.

### SUMMARY OF THE INVENTION

The present invention is intended for an apparatus for managing a configuration of at least one piece of application software including a plurality of program modules.

According to the present invention, the apparatus comprises: a storage operable to store a digital specification of the piece of application software, the digital specification including a plurality of module-specifications related to the plurality of program modules, respectively; a first processing element operable to change an objective module-specification in the digital specification; and a second processing element operable to determine an objective program module related to the objective module-specification and change the objective program module in the piece of application software.

This achieves the correct change of the program module configuration of application software.

According to another aspect of the present invention, the storage is operable to store a plurality of digital specifications corresponding to a plurality of pieces of application software, respectively, the first processing element is operable to change the objective module-specification in a selected digital specification, and the second processing element is operable to change the objective program module in a corresponding piece of application software in response to change of the objective module-specification. Further, the plurality of pieces of application software include first and second pieces of application software sharing at least one program module, the first processing element is operable to change at least one module-specification related to the at least one program module in a first digital specification describing the first piece of application software, and the second processing element is operable to change the at least one program module in the first piece of application software without changing the at least one program module in the second piece of application software.

Even when a program module is shared between the plurality of pieces of application software, the digital specifications describing the respective pieces of application software are different from each other, and the program module is changed based on each of the application software specifications. This achieves the change of the program module constituting each piece of application software without regard to the sharing of the program module.

The present invention is also intended for a method of managing a configuration of at least one piece of application software.

The present invention is also intended for a program for implementing in a computer an apparatus managing a configuration of at least one piece of application software including a plurality of program modules.

It is therefore an object of the present invention to provide an application software configuration management apparatus, an application software configuration management method, and a program which easily perform the management of a program module configuration in application software by giving attention to an application software specification for defining a piece of application software and program module specifications for defining respective program modules.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 illustrates a construction of an application software configuration management apparatus according to the present invention;

FIG. 2 is a flow chart for illustrating the operation of the application software configuration management apparatus;

FIGS. 3A to 3C illustrate a relationship between a piece of application software and an application software specification;

FIG. 4 illustrates associations established between the piece of application software and the application software specification and between a plurality of program modules and a plurality of program module specifications;

FIG. 5 is a flow chart for illustrating the change of a program module specification in an application software specification by a program module specification change section;

FIGS. 6A to 6D illustrate the operation of the program module specification change section changing a program module specification in the application software specification;

FIGS. 7A to 7F illustrate the changes of program modules in the piece of application software by a program module change section;

FIGS. 8A to 8D illustrate a plurality of pieces of application software sharing program modules with each other;

FIGS. 9A to 9D illustrates an instance where the change of a shared program module takes place in two pieces of application software sharing some program modules with each other;

FIGS. 10A to 10C illustrates another instance where the change of a shared program module takes place in two pieces of application software sharing some program modules with each other; and

FIG. 11 illustrates a computer system similar in operation to the application software configuration management apparatus.

### DESCRIPTION OF THE PREFERRED EMBODIMENTS

Preferred embodiments according to the present invention will now be described with reference to the drawings.

### First Preferred Embodiment

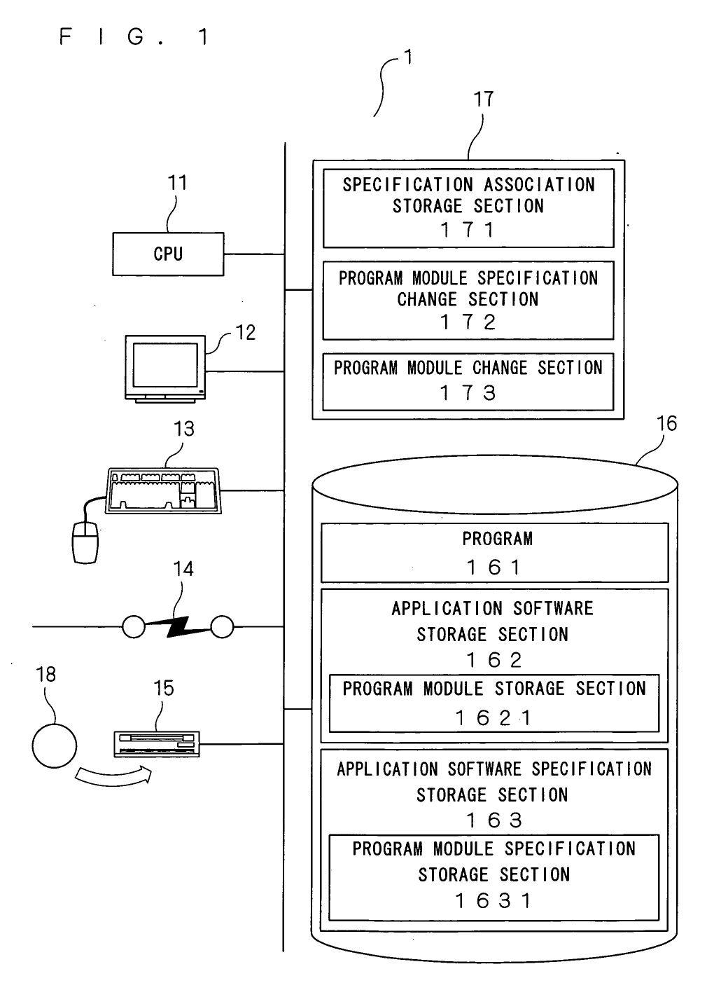

FIG. 1 illustrates a construction of an application software configuration management apparatus 1 according to the present invention.

The application software configuration management apparatus 1 is a commonly used personal computer, and includes a CPU 11, a display section 12, an input section 13, a network interface 14, a media drive 15, a storage section 16, and a memory 17.

The CPU 11 controls the entire application software configuration management apparatus 1. In particular, the CPU 11 executes in the memory 17 a program 161 recorded on a media disc 18 inserted in the media drive 15 to implement the functions of the application software configuration management apparatus 1.

The display section 12 is used to present information necessary for an application software configuration management process thereon. The input section 13 includes a mouse and a keyboard, and is used by an operator entering a command into the application software configuration management apparatus 1.

The network interface 14 is provided to connect the application software configuration management apparatus 1 and a network not shown to each other. The program 161 for implementing the functions of the application software configuration management apparatus 1 may be downloaded from a server not shown through the network interface 14.

The media drive 15 is used to read the program 161 recorded on the media disc 18. The program 161 read by the media drive 15 implements the functions of the application software configuration management apparatus 1.

The storage section 16 stores therein the program 161 read by the media drive 15. The storage section 16 includes an application software storage section 162, and an application software specification storage section 163.

The application software storage section 162 stores therein a plurality of pieces of application software managed by the application software configuration management apparatus 1. The application software storage section 162 has a plurality of folders. A piece of application software composed of a plurality of program modules is stored in each of the folders.

The application software storage section 162 includes a program module storage section 1621 for storing therein a plurality of program modules. The program module storage section 1621 stores a program module created by a client not shown and received through the network interface 14, and a program module recorded on the media disc 18 and read by the media drive 15. Examples of the program modules stored in the program module storage section 1621 include a program for updating a piece of application software and a patch for correcting a piece of application software. The program modules stored in the application software storage section 162 are not those constituting the piece of application software at this point.

The application software specification storage section 163 included in the storage section 16 is provided to store a plurality of application software specifications in the form of digital document files corresponding respectively to the plurality of pieces of application software stored in the application software storage section 162. In a process to be described later, when storing an application software specification in the application software specification storage section 163, a specification association storage section 171 associates the application software specification with a corresponding piece of application software. The application software specification contains descriptions about a specification for the corresponding piece of application software. Specifically, the application software specification defines a function implemented by the corresponding piece of application software and a specification for program modules for implementing the function. It is desirable that the application software specification is a structured document written in XML (extensible Markup Language) and the like because a contradiction is less likely to arise if a description change occurs and because there is a need to define a relationship between a function implemented by the corresponding piece of application software and the program modules for implementing the function.

The application software specification storage section 163 includes a program module specification storage section 1631 for storing a plurality of program module specifications corresponding respectively to the plurality of program modules stored in the program module storage section 1621. In a process to be described later, when storing a program module specification in the program module specification storage section 1631, the specification association storage section 171 associates the program module specification with a corresponding program module. The program module specification contains descriptions about a specification for the corresponding program module. The program module specification may define a function implemented by the corresponding program module and a specification for another program module for implementing the function. It is also desirable that the program module specification is a structured document because there is sometimes a need to define a relationship between a function implemented by the corresponding program module and another program module for implementing the function.

The memory 17 is a work area in which the CPU 11 executes the program 161 stored by the storage section 16. In consequence of the execution of the program 161 by the CPU 11, the functions of the specification association storage section 171, a program module specification change section 172, and a program module change section 173 are implemented in the memory 17.

The specification association storage section 171 performs the process of storing an application software specification in the application software specification storage section 163. In this process, the specification association storage section 171 establishes an association between the application software specification to be stored therein and a piece of application software corresponding to the application software specification. In the process of storing an application software specification in the application software specification storage section 163, the specification association storage section 171 references the file name of the application software specification to search the application software storage section 162 for a corresponding piece of application software. When the corresponding piece of application software is present in the application software storage section 162, the specification association storage section 171 establishes an association between the corresponding piece of application software and the application software specification being subjected to the storage process.

Similarly, in the process of storing a program module specification in the program module specification storage section 1631, the specification association storage section 171 references the file name of the program module specification to search the program module storage section 1621 for a corresponding program module. When the corresponding program module is present in the program module storage section 1621, the specification association storage section 171 establishes an association between the corresponding program module and the program module specification being subjected to the storage process.

The program module specification change section 172 is provided to change a program module specification described in an application software specification stored in the application software specification storage section 163. When an operator of the application software configuration management apparatus 1 desires to execute a change from a first program module constituting a piece of application software to a second program module, the program module specification change section 172 performs the process of executing a change from a first program module specification described in an application software specification stored in the application software specification storage section 163 to a second program module specification after reading the second program module specification associated with the second program module from the program module specification storage section 1631.

In response to the change from the first program module specification described in the application software specification to the second program module specification by the program module specification change section 172, the program module change section 173 executes the change from the first program module constituting the piece of application software to the second program module associated with the second program module specification. This results in a change in the configuration of the piece of application software.

The program module change section 173 reads from the program module storage section 1621 the second program module associated with the second program module specification to which the change is executed by the program module specification change section 172. Then, the program module change section 173 writes the read second program module into a folder which stores the piece of application software in the application software storage section 162 and corresponding to the application software specification in which the first program module specification is described. Thus, the change is executed from the first program module constituting the piece of application software to the second program module.

FIG. 2 is a flow chart for illustrating the operation of the application software configuration management apparatus 1.

First, in Step S1, the application software configuration management apparatus 1 receives/reads a piece of application software whose configuration is to be managed through a network not shown or from the media disc 18 to store the piece of application software in the application software storage section 162. For the storage of a plurality of pieces of application software, a plurality of folders included in the application software storage section 162 are used to store the plurality of pieces of application software, respectively.

In Step S2, the specification association storage section 171 stores in the application software specification storage section 163 an application software specification corresponding to the (or each) piece of application software stored in the application software storage section 162 through a network not shown or from the media disc 18. In this process, the specification association storage section 171 establishes an association between the application software specification to be stored in the application software specification storage section 163 and the piece of application software corresponding to the application software specification. In the process of storing the application software specification in the application software specification storage section 163, the specification association storage section 171 references the file name of the application software specification to search the application software storage section 162 for a corresponding piece of application software. When the corresponding piece of application software is present in the application software storage section 162, the specification association storage section 171 establishes an association between the corresponding piece of application software and the application software specification being subjected to the storage process.

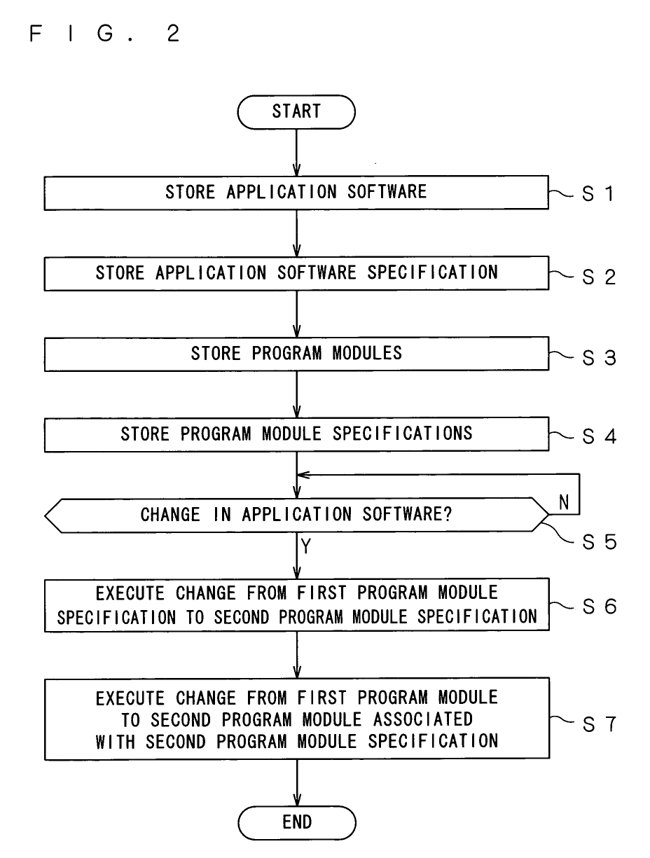

FIGS. 3A to 3C illustrate a relationship between a piece of application software and an application software specification.

FIG. 3A illustrates a relationship between a piece of application software and a plurality of program modules constituting the piece of application software. As shown in FIG. 3A, a program module “main.exe” for implementing a main function of a piece of application software ASP, a program module “GUI.com” for implementing a GUI function, a program module “InOut.com” for implementing an input/output function, and program modules “subset1.exe” and “subset2.exe” for implementing auxiliary functions for assisting the main function are stored in a folder in the application software storage section 162. For the piece of application software ASP, the program module “main.exe” is executed as the main function. When a screen display function is required, the program module “GUI.com” is called and executed. When the input/output function is required, the program module “InOut.com” is called and executed. The program module “main.exe” calls the program modules “subset1.exe” and/or “subset2.exe” as required to implement a function of the piece of application software ASP.

FIG. 3B illustrates the configuration of an application software specification. The application software specification contains descriptions about program module specifications for the program modules required for the piece of application software ASP shown in FIG. 3A. As shown in FIG. 3B, a program module specification named “main_spec” corresponding to the program module “main.exe” serving as the main function of the piece of application software ASP is described in the application software specification. A program module specification named “GUI_spec” corresponding to the program module “GUI.com” for executing the screen display function, and a program module specification named “InOut_spec” corresponding to the program module “InOut.com” for executing the input/output function are also described in the application software specification. Program module specifications named “subset1_spec” and “subset2_spec” corresponding to the program modules “subset1.exe” and “subset2.exe” for executing the auxiliary functions are also described in the application software specification.

FIG. 3C shows an example of the application software specification written in the form of a structured document. The application software specification shown in FIG. 3C is defined using a pair of tags <ASP_spec> and </ASP_spec>, which mean that the descriptions between the pair of tags represent the application software specification. As shown in FIG. 3C, program module specification names corresponding to the respective program modules constituting the piece of application software ASP are described between a pair of tags <module_specification> and </module_specification>. In this application software specification, the name of the program module specification “main_spec” is described between a pair of tags <main_module> and </main_module> defining the main function. This defines the correspondence of the program module specification “main_spec” to the program module “main.exe” serving as the main function in the application software specification. Similarly, the program module specifications “GUI_spec,” “InOut_spec,” “subset1_spec” and “subset2_spec” are defined to correspond to the respective functions.

The technique for description of the application software specification is not limited to the structured document shown in FIG. 3C. For example the application software specification may be written in CSV (Comma Separated Value) format or written in a conventional text format.

Referring again to FIG. 2, the application software configuration management apparatus 1 stores program modules in the program module storage section 1621 through a network not shown or by reading the media disc 18 in Step S3. The program modules to be stored in the program module storage section 1621 include a program module for a version upgrade of the piece of application software, a revision of a program module constituting the piece of application software, a patch for correcting bugs in the piece of application software and the like, and do not constitute the piece of application software at this point.

The plurality of program modules are illustrated above as stored in a collective manner in the program module storage section 1621. For convenience of management, folders may be created according to the functions of program modules in the program module storage section 1621, and be adapted to store the program modules having functions corresponding to the functions indicated by the respective folders.

In Step S4, the specification association storage section 171 stores program module specifications in the program module specification storage section 1631 through a network not shown or by reading the media disc 18. The program module specifications to be stored in the program module specification storage section 1631 correspond respectively to the program modules stored in the program module storage section 1621. In the process of storing a program module specification in the program module specification storage section 1631, the specification association storage section 171 references the file name of the program module specification to search the program module storage section 1621 for a corresponding program module. When the corresponding program module is present in the program module storage section 1621, the specification association storage section 171 establishes an association between the corresponding program module and the program module specification being subjected to the storage process.

Like the application software specification shown in FIGS. 3A to 3C, each of the program module specifications to be stored in the program module specification storage section 1631 contains descriptions about a function of a corresponding program module. It is assumed herein that each of the program module specifications, as well as the application software specification, is in the form of a structured document.

The plurality of program module specifications are illustrated above as stored in a collective manner in the program module specification storage section 1631. For convenience of management, folders may be created according to the functions of program modules in the program module specification storage section 1631, and be adapted to store the program module specifications corresponding to the program modules having functions corresponding to the functions indicated by the respective folders.

The specification association storage section 171 is illustrated above as establishing the associations by referencing the file names of the application software and program module specifications in Steps S2 and S4. However, an operator of the application software configuration management apparatus 1 may manipulate the input section 13 to cause the specification association storage section 171 to function, thereby establishing the associations. Additionally, the associations may be established by referencing unique identifiers previously assigned to a piece of application software and an application software specification or to program modules and program module specifications, respectively.

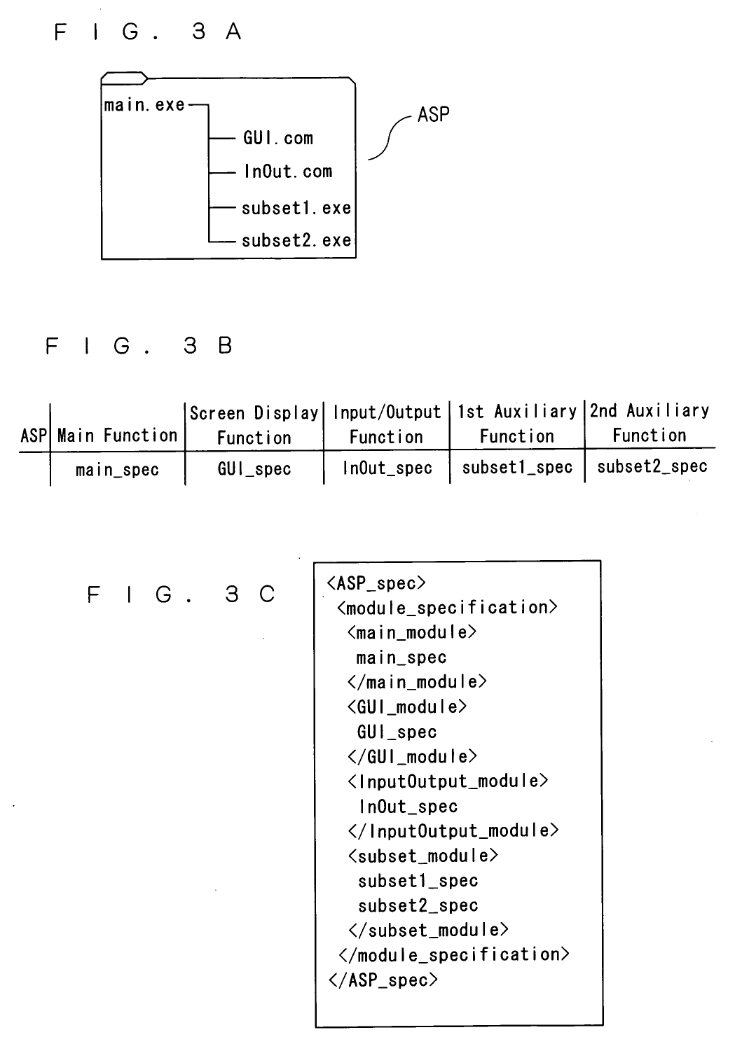

FIG. 4 illustrates associations established between the piece of application software and the application software specification and between the plurality of program modules and the plurality of program module specifications as a result of the execution of Steps S1 to S4. As shown in FIG. 4, the piece of application software and the application software specification corresponding to the piece of application software are associated with each other, and the plurality of program modules constituting the piece of application software and the program module specifications corresponding to the program modules are associated with each other. Such associations allow a process to be described later to change a program module in response to a change of a program module specification, consequently achieving a change in the piece of application software.

Referring again to FIG. 2, the application software configuration management apparatus 1 is in a standby condition pending a change in a piece of application software in Step S5. The processing proceeds to Step S6 when a version upgrade of a piece of application software, a revision of a program module or a patching process for debugging takes place.

In Step S6, the program module specification change section 172 executes the change of a program module specification described in the application software specification for the purpose of making the change in the piece of application software occurring in Step S5.

FIG. 5 is a flow chart for illustrating the change of a program module specification in an application software specification by the program module specification change section 172. A change from a first program module “subset1.exe” (corresponding to a first program module specification) constituting a piece of application software to a second program module “subset10.exe” (corresponding to a second program module specification) will be described as an example.

In Step S51, the program module specification change section 172 reads into the memory 17 an application software specification corresponding to a piece of application software to be changed.

In Step S52, the operator of the application software configuration management apparatus 1 manipulates the input section 13 to search the program module specification storage section 1631 for the second program module specification.

Because of the change from the first program module “subset1.exe” to the second program module “subset10.exe,” the operator searches for the second program module specification “subset10_spec” corresponding to the second program module “subset10.exe.”

If the search fails to find the second program module specification in Step S52, the second program module “subset10.exe” and the second program module specification “subset10_spec” corresponding thereto may be stored in the program module storage section 1621 and the program module specification storage section 1631, respectively, and be associated with each other at this point.

If the search succeeds in finding the second program module specification, the program module specification change section 172 executes the change from the first program module specification to the second program module specification in the application software specification in Step S53.

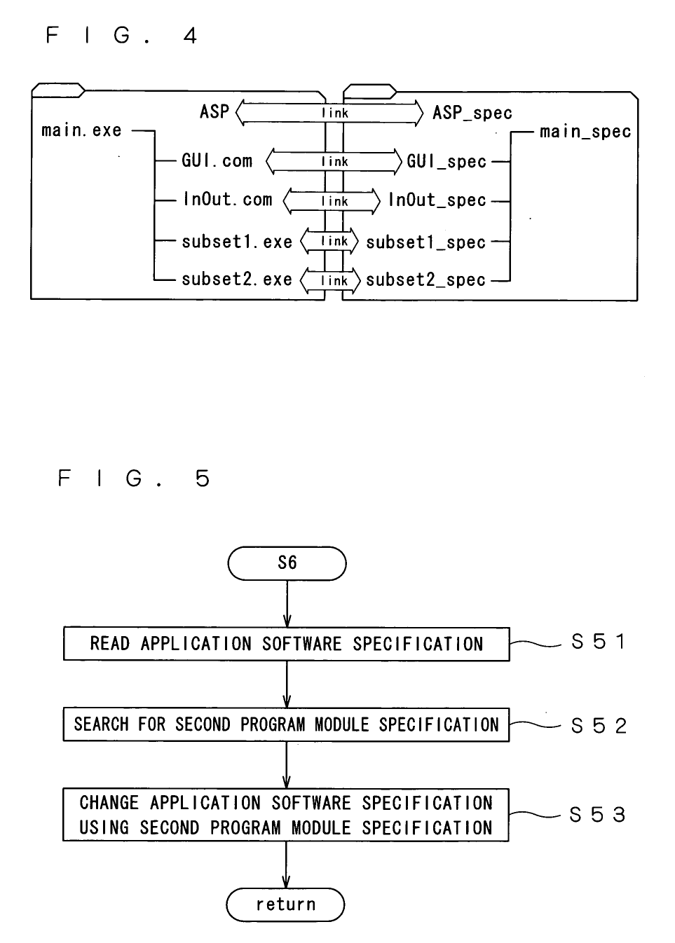

FIGS. 6A to 6D illustrate the operation of the program module specification change section 172 executing the change from the first program module specification to the second program module specification in the application software specification in Step S53.

FIG. 6A shows a configuration of the application software specification prior to the processing in Step S53. As shown in FIG. 6A, this configuration is similar to the configuration of the application software specification shown in FIG. 3B. FIG. 6B shows a configuration as a result of the change from the first program module specification to the second program module specification in the application software specification by the program module specification change section 172 after the processing in Step S53. As shown in FIG. 6B, the program module specification for a first auxiliary function is changed from “subset1_spec” to “subset10_spec.” FIGS. 6C and 6D show the application software specifications of FIGS. 6A and 6B written using a technique of a structured document.

Referring again to FIG. 2, the program module change section 173 executes the change of a program module constituting the piece of application software in Step S7, based on the application software specification in which the change is made in Step S6. In response to the change from the first program module specification to the second program module specification in the application software specification, the program module change section 173 searches the program module storage section 1621 for the second program module associated with the second program module specification. To execute the program module change in the piece of application software associated with the application software specification in which the change is made, the program module change section 173 stores the second program module found as a result of the search of the program module storage section 1621 in a folder in which the piece of application software in the application software storage section 162 is stored. Also, in response to the deletion of a program module specification in the application software specification, the program module change section 173 deletes a program module associated with the program module specification in a folder in which the piece of application software in the application software storage section 162 is stored.

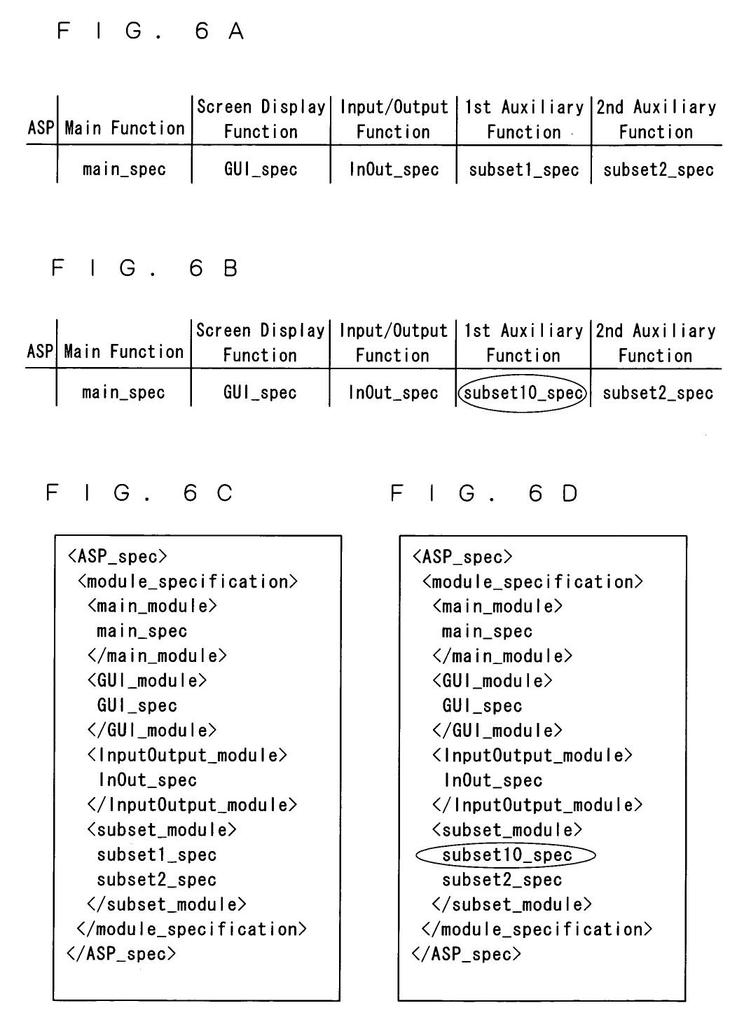

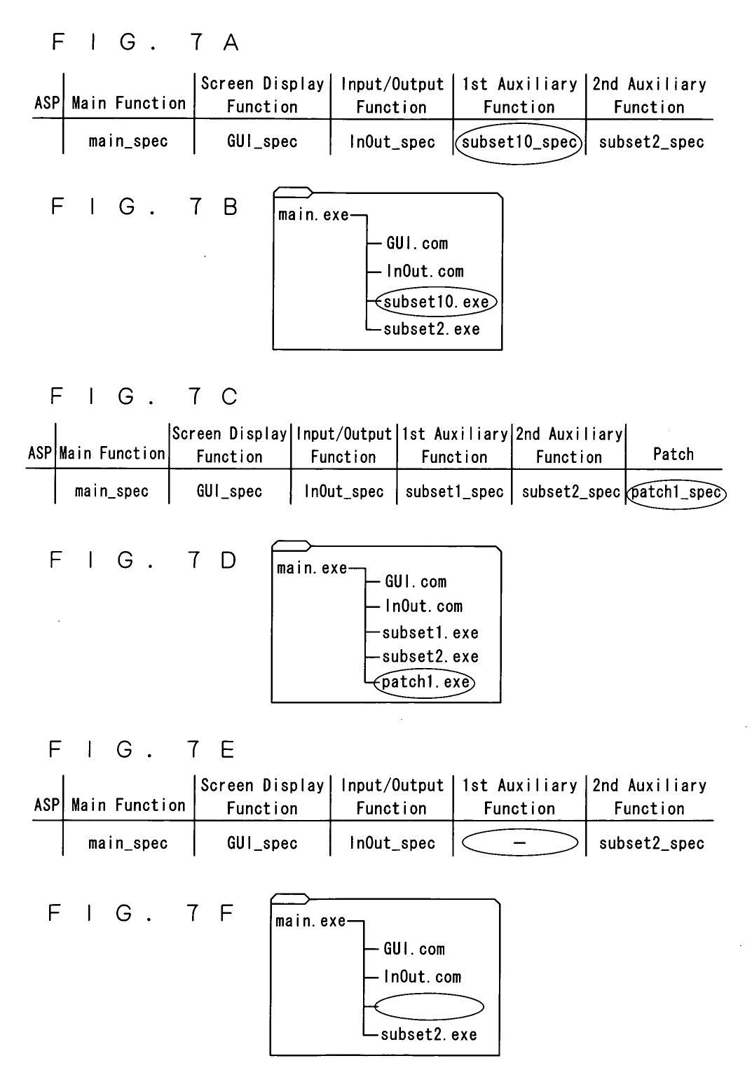

FIGS. 7A to 7F illustrate changes of program modules in the piece of application software by the program module change section 173 in response to the changes of program module specifications described in the application software specification by the program module specification change section 172.

FIGS. 7A and 7B illustrate the change from the first program module to the second program module in the piece of application software in response to the change from the first program module specification to the second program module specification shown in FIGS. 6A to 6D. The program module change section 173 extracts the second program module from the program module storage section 1621 to write the second program module into a folder in which the corresponding piece of application software in the application software storage section 162 is stored. The program module change section 173 deletes the first program module “subset1.exe” associated with the first program module specification “subset1_spec.” Thus, the second program module “subset10.exe” becomes a component of the piece of application software in place of the first program module “subset1.exe” implementing the first auxiliary function, as shown in FIGS. 7A and 7B.

FIGS. 7C and 7D illustrate the addition of a program module for patching and the like for a change in the piece of application software. As shown in FIGS. 7C and 7D, an item “patch” is added to the application software specification, and a program module specification “patch1_spec” is added in corresponding relation to the item. In this case, the program module change section 173 extracts a program module from the program module storage section 1621 to write the program module into a folder in which the corresponding piece of application software in the application software storage section 162 is stored. As a result, a program module “patch1.exe” associated with the program module specification “patch1_spec” is added as a component of the piece of application software, as shown in FIGS. 7C and 7D.

FIGS. 7E and 7F illustrate the deletion of a program module for a change in the piece of application software. As shown in FIGS. 7E and 7F, the program module specification “subset1_spec” corresponding to the item “1st Auxiliary Function” is deleted in the application software specification. In this case, the program module change section 173 deletes the program module “subset1.exe” associated with the deleted program module specification “subset1_spec.” As a result, the configuration of the piece of application software is such that the program module “subset1.exe” is deleted, as shown in FIGS. 7E and 7F.

Thus, when the application software configuration management apparatus 1 shown in FIG. 1 performs the operation illustrated in the flow chart of FIG. 2 to thereby change a program module specification which defines a program module in an application software specification which defines a piece of application software, the program module associated with the program module specification is changed. This achieves the correct change of the program module constituting the piece of application software.

### Second Preferred Embodiment

The change of the program module in the single piece of application software has been described hereinabove. The application software configuration management apparatus 1 according to the present invention is capable of processing even when a plurality of pieces of application software share a program module with each other.

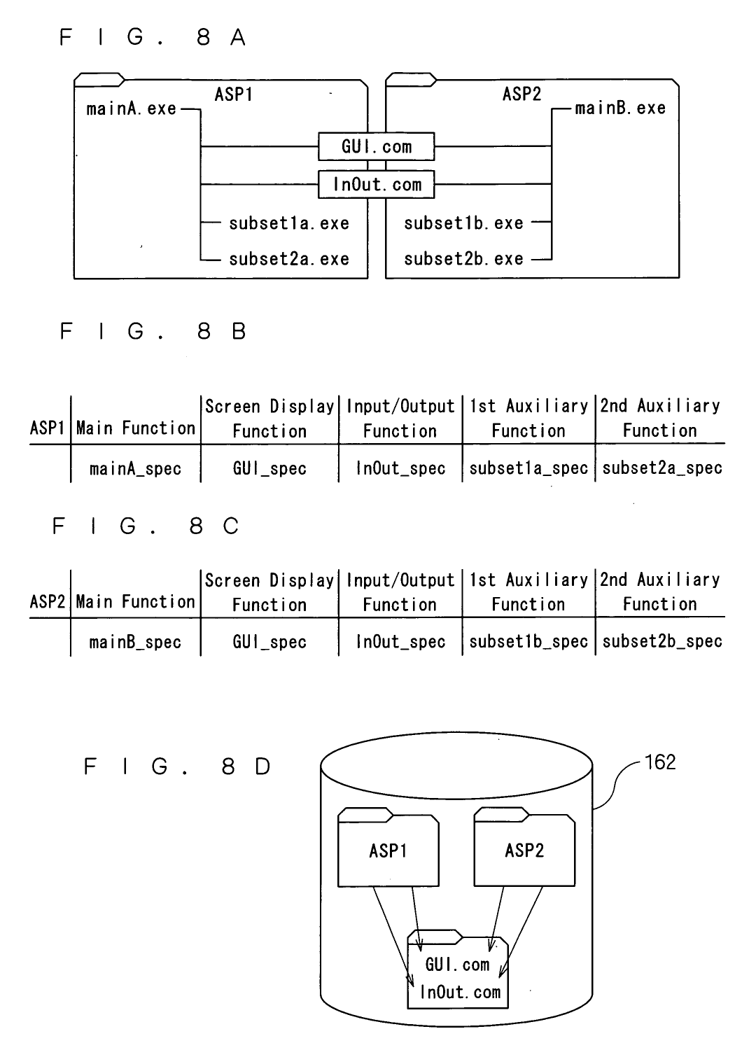

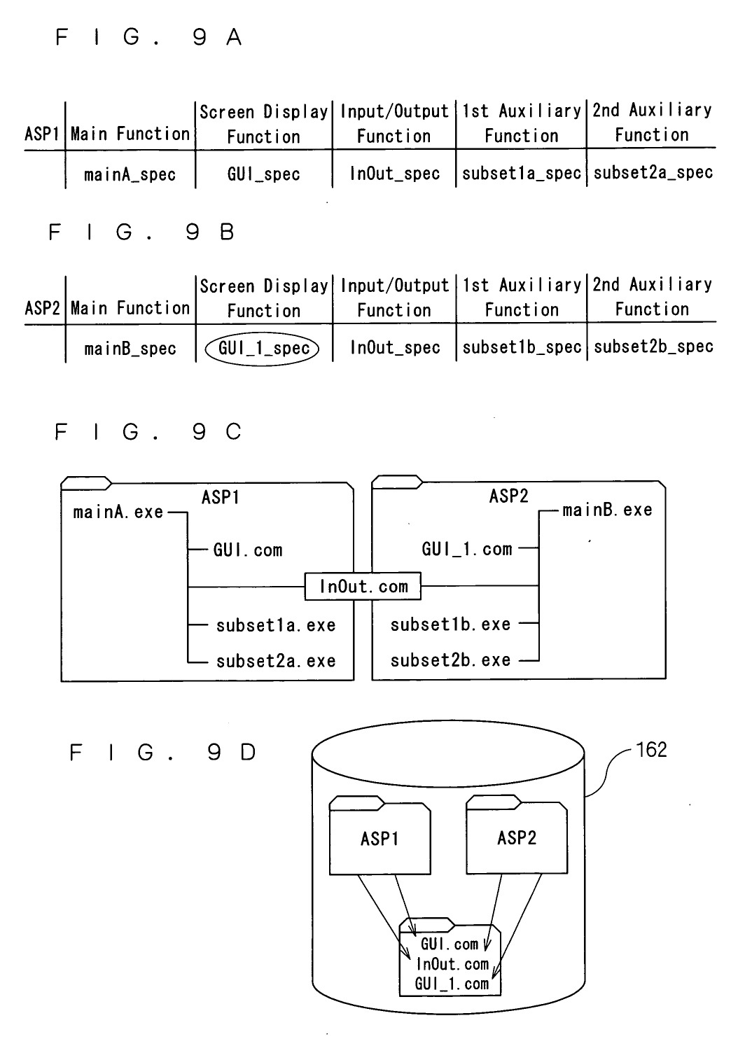

FIG. 8A shows that two pieces of application software ASP1 and ASP2 share the program module “GUI.com” for implementing the screen display function and the program module “InOut.com” for implementing the input/output function with each other.

FIGS. 8B and 8C show the configurations of application software specifications (digital specifications) for the two pieces of application software ASP1 and ASP2, respectively. As shown in FIGS. 8B and 8C, the program module specification “GUI_spec” related to the image display function and the program module specification “InOut_spec” related to the input/output function are described in each of the application software specifications for the two pieces of application software ASP1 and ASP2.

FIG. 8D shows that the two pieces of application software ASP1 and ASP2 share the program modules “GUI.com” and “InOut.com” with each other in the application software storage section 162. As mentioned above, the two pieces of application software ASP1 and ASP2 are stored in the respective folders in the application software storage section 162. The program modules “GUI.com” and “InOut.com” shared between the two pieces of application software ASP1 and ASP2 are stored in a folder different from the folders storing the two pieces of application software ASP1 and ASP2.

It should be noted that a program module shared between pieces of application software need not be stored in a folder in the application software storage section 162.

As described above, the two pieces of application software ASP1 and ASP2 share the program modules “GUI.com” and “InOut.com” for the screen display function and the input/output function with each other. Under such conditions, when the shared program module “GUI.com” is not changed in the piece of application software ASP1 but is changed to its revision “GUI_{—}1.com” in the piece of application software ASP2, there is sometimes an error such that the program module “GUI.com” is deleted by mistake. Another error is such that the program module for implementing the screen display function in the piece of application software ASP1 is also changed to the revision “GUI_.com” although only the screen display function in the piece of application software ASP2 must be changed.

The application software configuration management apparatus 1 according to the present invention, however, does not cause the above-mentioned errors because the application software specifications are associated with the respective pieces of application software and the program modules are associated with the respective program module specifications described in the application software specifications.

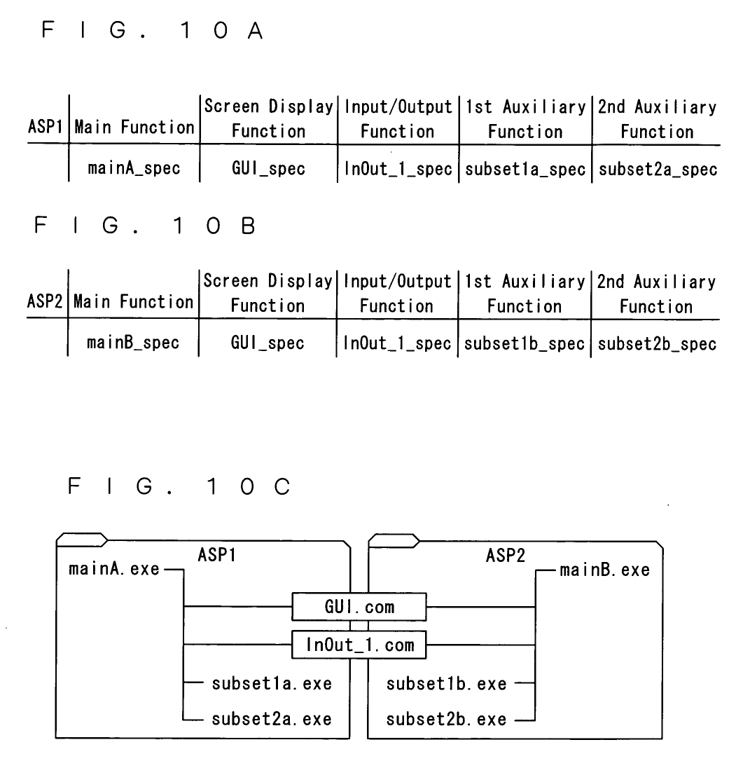

FIGS. 9A to 9D illustrate an instance where the change of a shared program module takes place in the two pieces of application software ASP1 and ASP2 sharing some of the above-mentioned program modules with each other in the application software configuration management apparatus 1.

FIGS. 9A and 9B show the application software specifications for the two pieces of application software ASP1 and ASP2 shown in FIGS. 8B and 8C, respectively. In particular, FIG. 9B shows that the program module specification related to the program module “GUI.com” for implementing the screen display function is changed. Because the program module specification related to the screen display function is changed by the program module specification change section 172, it is found from FIG. 9B that the program module specification in the application software specification for the piece of application software ASP2 is changed from “GUI_spec” to “GUI_{—}1_spec” as compared with the application software specification shown in FIG. 8C. On the other hand, no change is made in the application software specification for the piece of application software ASP1 by the program module specification change section 172.

As a result, the program module “GUI.com” constituting the piece of application software ASP2 is changed by the program module change section 173. As shown in FIG. 9C, the program module for implementing the screen display function remains unchanged as “GUI.com” in the piece of application software ASP1, but is changed to “GUI_{—}1.com” in the piece of application software ASP2 so that the sharing relationship is broken. On the other hand, the program module “InOut.com” for implementing the input/output function is not changed but remains shared because the program module specifications are unchanged both in the two application software specifications.

FIG. 9D illustrates the program module “InOut.com” as shared between the two pieces of application software ASP1 and ASP2 in the application software storage section 162 when the change shown in FIG. 9C is made. As shown in FIG. 9D, the program module “InOut.com” remains shared between the two pieces of application software ASP1 and ASP2, but only the piece of application software ASP1 has the program module “GUI.com” as a component whereas the piece of application software ASP2 has the program module “GUI_{—}1.com” as a component.

Thus, in changing a shared program module in one of the pieces of application software which share some program modules with each other, the application software configuration management apparatus 1 is capable of managing the program module configuration in the pieces of application software.

The folder which stores the program modules “GUI.com” and “GUI_{—}1.com” shown in FIG. 9D remains unchanged after the change of the program module. However, the program modules “GUI.com” and “GUI_{—}1.com” may be moved to the respective folders in which the pieces of application software ASP1 and ASP2 are stored during the program module change process.

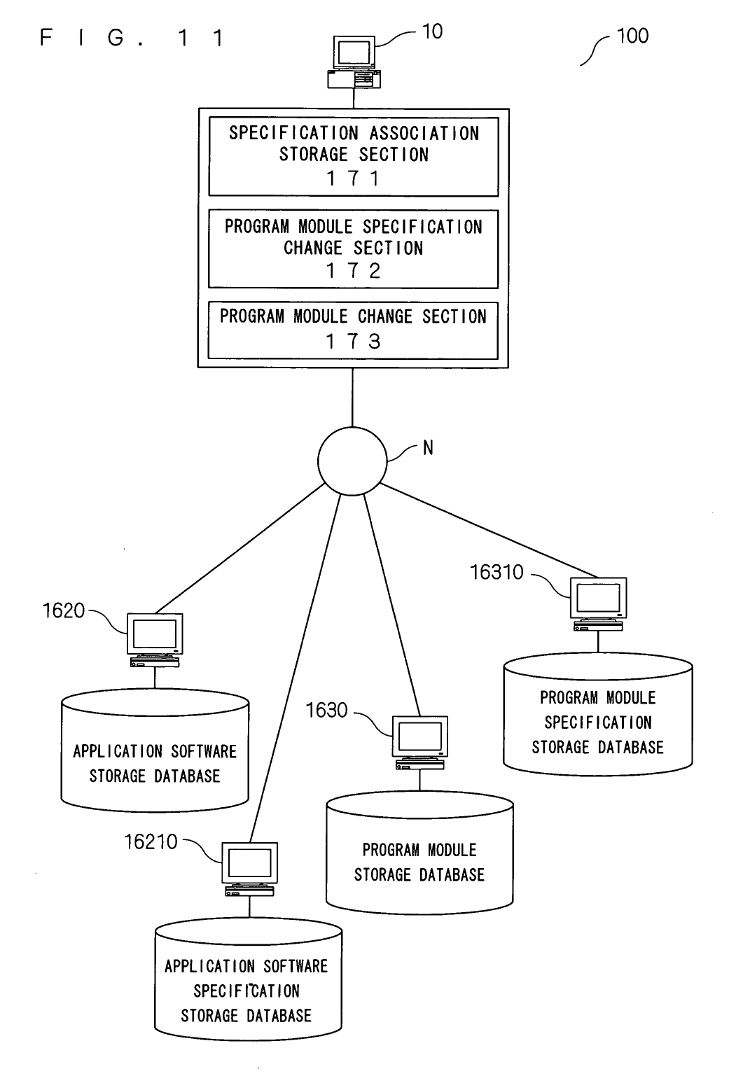

FIGS. 10A to 10C illustrate another instance where the change of a shared program module takes place in the two pieces of application software ASP1 and ASP2 sharing some of the above-mentioned program modules with each other in the application software configuration management apparatus 1.

FIGS. 10A and 10B show that program module specifications in the application software specifications for the two pieces of application software ASP1 and ASP2 are changed for the purpose of changing the shared program module “InOut.com” for implementing the input/output function to a program module “InOut_{—}1.com” in each of the two pieces of application software ASP1 and ASP2. As shown in FIGS. 10A and 10B, the program module specification related to the program module for implementing the input/output function is changed to “InOut_{—}1_spec” in each of the application software specifications for the pieces of application software ASP1 and ASP2 by the program module specification change section 172.

As a result, the two pieces of application software ASP1 and ASP2 in the application software storage section 162 share the program modules “GUI.com” and “InOut_{—}1.com” with each other, as shown in FIG. 10C. As shown, the program module “GUI.com” subjected to no change remains unchanged in both the two pieces of application software ASP1 and ASP2, but the change to the program module “InOut_{—}1.com” is made in both the two pieces of application software ASP1 and ASP2.

Thus, in changing a shared program module in the pieces of application software which share some program modules with each other, the application software configuration management apparatus 1 is capable of managing the program module configuration in the pieces of application software.

Thus, when the application software configuration management apparatus 1 shown in FIG. 1 performs the operation illustrated in the flow chart of FIG. 2 to thereby change a program module specification which defines a program module in application software specifications which define respective pieces of application software, the program module associated with the program module specification is changed. This achieves the correct change of the program module constituting the pieces of application software.

Modifications

The application software configuration management apparatus 1 is implemented in a single computer in the above description. However, the construction of the application software configuration management apparatus 1 may be implemented in a computer system including a plurality of computers connected by way of a network.

FIG. 11 illustrates a computer system 100 similar in operation to the application software configuration management apparatus 1. The computer system 100 includes an application software configuration management apparatus 10 and computers 1620, 1630, 16210 and 16310 which are connected to each other by way of a network N. The application software configuration management apparatus 10 is similar in function to the application software configuration management apparatus 1 except that the application software configuration management apparatus 10 does not has the functions of the application software storage section 162 and the application software specification storage section 163. The computer 1620 is a computer for managing an application software storage database. The computer 1630 is a computer for managing an application software specification storage database. The computer 16210 is a computer for managing a program module storage database. The computer 16310 is a computer for managing a program module specification storage database.

The computer system 100 shown in FIG. 11 can perform the operation as illustrated in the flow chart of FIG. 2 by communicating pieces of application software, application software specifications, program modules and program module specifications by way of the network N. Thus, when the computer system 100 shown in FIG. 11 performs the operation illustrated in the flow chart of FIG. 2 to thereby change a program module specification which defines a program module in an application software specification which defines a piece of application software, the program module associated with the program module specification is changed also in this case. This achieves the correct change of the program module constituting the piece of application software.

The application software according to the present invention is not limited to application software used in typical computers. The present invention is applicable, for example, to system development software for use in system development and to business-application software.

While the invention has been described in detail, the foregoing description is in all aspects illustrative and not restrictive. It is understood that numerous other modifications and variations can be devised without departing from the scope of the invention.

What is claimed is:

1. An apparatus for managing a configuration of a piece of application software including a plurality of program modules, said apparatus comprising:
a storage operable to store a digital specification of said piece of application software, said digital specification including a plurality of module-specifications related to said plurality of program modules, respectively;
a first processing element operable to change an objective module-specification in said digital specification; and
a second processing element operable to determine an objective program module related to said objective module-specification and change said objective program module in said piece of application software.

2. The apparatus according to claim 1, wherein
said storage is operable to store a plurality of digital specifications corresponding to a plurality of pieces of application software, respectively,
said first processing element is operable to change said objective module-specification in a selected digital specification, and
said second processing element is operable to change said objective program module in a corresponding piece of application software in response to change of said objective module-specification.

3. The apparatus according to claim 2, wherein
said plurality of pieces of application software include first and second pieces of application software sharing at least one program module,
said first processing element is operable to change at least one module-specification related to said at least one program module in a first digital specification describing said first piece of application software, and
said second processing element is operable to change said at least one program module in said first piece of application software without changing said at least one program module in said second piece of application software.

4. The apparatus according to claim 1, wherein
each module-specification has a module-specification name related to a module name of a corresponding program module,
said first processing element is operable to change said module-specification name of said objective module-specification, and
said second processing element is operable to change said module name of said objective program module.

5. The apparatus according to claim 4, wherein
said first processing element is operable to replace a first module-specification name in said digital specification with a second module-specification name, and
said second processing element is operable to replace a first program module having a first module name in said piece of application software with a second program module having a second module name,
wherein said first and second module names are related to said first and second module-specification names, respectively.

6. The apparatus according to claim 4, wherein
said first processing element is operable to delete a first module-specification name from said digital specification, and
said second processing element is operable to delete from said piece of application software a first program module having a first module name related to said first module-specification name.

7. The apparatus according to claim 4, wherein
said first processing element is operable to add a first module-specification name to said digital specification, and
said second processing element is operable to add a first program module to said piece of application software, said first program module having a first module name related to said first module-specification name.

8. The apparatus according to claim 7, wherein
said second processing element is further operable to fetch said first program module from another storage and add said first program module to said piece of application software.

9. A method of managing a configuration of a piece of application software including a plurality of program modules, said method comprising the steps of:
a) storing a digital specification of said piece of application software, said digital specification including a plurality of module-specifications related to said plurality of program modules, respectively;
b) changing an objective module-specification in said digital specification; and
c) determining an objective program module related to said objective module-specification and changing said objective program module in said piece of application software.

10. The method according to claim 9, wherein
the step a) comprises the step of storing a plurarity of digital specifications corresponding to a plurality of pieces of application software, respectively,
the step b) comprises the step of changing said objective module-specification in a selected digital specification, and
the step c) comprises the step of changing said objective program module in a corresponding piece of application software in response to change of said objective module-specification.

11. The method according to claim 10, wherein
said plurality of pieces of application software include first and second pieces of application software sharing at least one program module,
the step b) comprises the step of changing at least one module-specification related to said at least one program module in a first digital specification describing said first piece of application software, and
the step c) comprises the step of changing said at least one program module in said first piece of application software without changing said at least one program module in said second piece of application software.

12. A program for implementing in a computer an apparatus managing a configuration of a piece of application software including a plurality of program modules, said program causing said computer to perform the steps of:
a) storing a digital specification of said piece of application software, said digital specification including a plurality of module-specifications related to said plurality of program modules, respectively;
b) changing an objective module-specification in said digital specification; and
c) determining an objective program module related to said objective module-specification and changing said objective program module in said piece of application software.

13. The program according to claim 12, wherein
the step a) comprises the step of storing a plurarity of digital specifications corresponding to a plurality of pieces of application software, respectively,
the step b) comprises the step of changing said objective module-specification in a selected digital specification, and
the step c) comprises the step of changing said objective program module in a corresponding piece of application software in response to change of said objective module-specification.

14. The program according to claim 13, wherein
said plurality of pieces of application software include first and second pieces of application software sharing at least one program module,
the step b) comprises the step of changing at least one module-specification related to said at least one program module in a first digital specification describing said first piece of application software, and
the step c) comprises the step of changing said at least one program module in said first piece of application software without changing said at least one program module in said second piece of application software.

15. A software management apparatus, comprising:
a first storage operable to store a piece of application software including a main program module and a plurality of sub-program modules linked to said main program module in accordance with a module-configuration of said piece of application software;
a second storage operable to store a digital specification having descriptions of said module-configuration of said piece of application software; and
a control element operable to modify the links between said main program module and said plurality of sub-program modules in response to modification in said descriptions of said module-configuration in said digital specification.
